(19) United States
(12) Patent Application Publication
(10) Pub. No.: US 2021/0374399 A1
(43) Pub. Date: Dec. 2, 2021

(54) CONTACTLESS BIOMETRICS MONITORING SYSTEM AND METHOD

(71) Applicant: Samsung Electronics Co., Ltd., Suwon-si (KR)

(72) Inventors: Chor Hei Ernest Cheung, Milpitas, CA (US); Yelei Li, San Jose, CA (US); Lin Sun, Mountain View, CA (US); Caleb J. Li, Cupertino, CA (US)

(21) Appl. No.: 16/942,692

(22) Filed: Jul. 29, 2020

Related U.S. Application Data
(60) Provisional application No. 63/031,499, filed on May 28, 2020.

(51) Int. Cl. G06K 9/00

(52) U.S. Cl. CPC G06K 9/00516; G06K 9/0055; G06K 9/0053; G06K 9/00926

(57) ABSTRACT

A contactless biometrics monitoring system includes: a first device to transmit a modulated signal into an environment, the modulated signal being modulated to amplify one or more biometric patterns of a user located within the environment; and a second device to receive a reflection of the modulated signal off the user located within the environment. The reflection includes a vibration component, and the vibration component indicates biometric information of the user corresponding to the one or more biometric patterns amplified by the modulated signal.

### CROSS-REFERENCE TO RELATED APPLICATION(S)

This application claims priority to and the benefit of U.S. Provisional Application No. 63/031,499, filed on May 28, 2020, entitled “STRUCTURED SOUND/RF SYSTEM FOR BIOMETRICS MONITORING,” the entire content of which is incorporated by reference herein.

### FIELD

Aspects of one or more example embodiments of the present disclosure relate to a system for contactless biometrics monitoring, and a method for contactless biometrics monitoring.

### BACKGROUND

Biometrics measuring devices, for example, such as wearable smart devices (e.g., smart watches, fitness trackers, and/or the like), smart phones (e.g., a pulse reader of a smart phone), and/or the like, may measure various biometrics (e.g., various vitals) of a user, for example, such as a heart rate, a respiration rate, and/or the like, while the device is in contact with (or in close proximity to) the user. For example, these devices may generally include one or more sensors that may be in contact with (or in close proximity to) the user in order to measure the biometrics of the user. However, when these devices are not in contact with (or in close proximity to) the user, the sensors thereof may be unable to acurately measure the biometrics of the user.

The above information disclosed in this Background section is for enhancement of understanding of the background of the present disclosure, and therefore, it may contain information that does not constitute prior art.

### SUMMARY

One or more example embodiments of the present disclosure are directed to a contactless biometric monitoring system, and a method of contactless biometric monitoring.

According to one or more example embodiments of the present disclosure, a contactless biometrics monitoring system, includes: a first device configured to transmit a modulated signal into an environment, the modulated signal being modulated to amplify one or more biometric patterns of a user located within the environment; and a second device configured to receive a reflection of the modulated signal off the user located within the environment. The reflection includes a vibration component, and the vibration component indicates biometric information of the user corresponding to the one or more biometric patterns amplified by the modulated signal.

In an example embodiment, the first device may be configured to generate the modulated signal by modulating a source audio signal or a source radio frequency (RF) signal according to a frequency range of the one or more biometric patterns.

In an example embodiment, the second device may be further configured to isolate the reflection from the modulated signal.

In an example embodiment, one of the first device and the second device may be configured as a main device, and the other of the first device and the second device may be configured as an ancillary device; and the main device may be configured to dynamically activate the ancillary device into the system according to a location of the user within the environment.

In an example embodiment, to dynamically activate the ancillary device into the system, the main device may be configured to: transmit a modulated initialization signal toward a measurement area of the environment; detect a response transmitted by the ancillary device located within the measurement area of the environment; and generate a geographic distance map between the main device and the ancillary device that transmits the response.

In an example embodiment, the ancillary device may be configured to: detect the initialization signal from the environment; compare a signal strength of the initialization signal with a threshold strength; and transmit the response into the environment in response to the signal strength being greater than the threshold strength.

In an example embodiment, the main device may be further configured to: calculate a signal variation in the measurement area; compare the signal variation in the measurement area with that of an adjacent area; and determine that the measurement area includes a moving object in response to the signal variation in the measurement area being greater than that of the adjacent area.

In an example embodiment, the system may further include: a processor; and memory connected to the processor and storing instructions that, when executed by the processor, cause the processor to: apply a convolution to the reflection to determine reflected wavelet locations; and extract the biometric information from the reflected wavelet locations.

In an example embodiment, to extract the biometric information from the reflected wavelet locations, the instructions may further cause the processor to: calculate an inter-wavelet interval from the reflected wavelet locations; and extract the biometric information from the inter-wavelet interval.

In an example embodiment, to extract the biometric information from the reflected wavelet locations, the instructions may further cause the processor to: calculate amplitude envelops of the reflected wavelet locations; and extract the biometric information from the amplitude envelops.

In an example embodiment, the system may further include: a biometrics estimation training system communicably connected to the processor; and a contact device communicably connected to the biometrics estimation training system, and configured to provide biometrics measurements of the user to the biometrics estimation training system. The biometrics estimation training system may be configured to train an optimizer to estimate the biometric information from the reflection by minimizing a loss between the extracted biometric information and the biometrics measurements provided by the contact device.

According to one or more example embodiments of the present disclosure, a method for contactless biometrics monitoring includes: transmitting, by a first device, a modulated signal into an environment, the modulated signal being modulated to amplify one or more biometric patterns of a user located within the environment; receiving, by a second device, the modulated signal reflecting off the user located within the environment; and isolating, by the second device, a reflection from the modulated signal. The reflection includes a vibration component, and the vibration component indicates biometric information of the user corresponding to the one or more biometric patterns amplified by the modulated signal.

In an example embodiment, the method may further include: generating, by the first device, the modulated signal by modulating a source audio signal or a source radio frequency (RF) signal according to a frequency range of the one or more biometric patterns.

In an example embodiment, one of the first device and the second device may be configured as a main device, and the other of the first device and the second device may be configured as an ancillary device, and the method may further include: dynamically activating, by the main device, the ancillary device according to a location of the user within the environment.

In an example embodiment, to dynamically activate the ancillary device, the method may further include: transmitting, by the main device, a modulated initialization signal toward a measurement area of the environment; detecting, by the main device, a response transmitted by the ancillary device located within the measurement area of the environment; and generating, by the main device, a geographic distance map between the main device and the ancillary device that transmits the response, and to transmit the response by the ancillary device, the method may further include: detecting, by the ancillary device, the initialization signal from the environment; comparing, by the ancillary device, a signal strength of the initialization signal with a threshold strength; and transmitting, by the ancillary device, the response into the environment in response to the signal strength being greater than the threshold strength.

In an example embodiment, the method may further include: calculating, by the main device, a signal variation in the measurement area; comparing, by the main device, the signal variation in the measurement area with that of an adjacent area; and determining, by the main device, that the measurement area includes a moving object in response to the signal variation in the measurement area being greater than that of the adjacent area.

In an example embodiment, the method may further include: applying, by a processor, a convolution to the reflection to determine reflected wavelet locations; and extracting, by the processor, the biometric information from the reflected wavelet locations.

In an example embodiment, to extract the biometric information from the reflected wavelet locations, the method may further include: calculating, by the processor, an inter-wavelet interval from the reflected wavelet locations; and extracting, by the processor, the biometric information from the inter-wavelet interval.

In an example embodiment, to extract the biometric information from the reflected wavelet locations, the method may further include: calculating, by the processor, amplitude envelops of the reflected wavelet locations; and extracting, by the processor, the biometric information from the amplitude envelops.

In an example embodiment, the method may further include: receiving, by a training system, biometric measurements of the user from a contact device; and training, by the training system, the processor to estimate the biometric information from the reflection by minimizing a loss between the extracted biometric information and the biometrics measurements provided by the contact device.

### BRIEF DESCRIPTION OF THE DRAWINGS

The above and other aspects and features of the present disclosure will become more apparent to those skilled in the art from the following detailed description of the example embodiments with reference to the accompanying drawings.

FIG. 1 illustrates a contactless biometric monitoring system according to one or more example embodiments of the present disclosure.

FIG. 2 illustrates a block diagram of a receiver device and a transmitter device according to one or more example embodiments of the present disclosure.

FIG. 3 illustrates waveform diagrams of various examples of different modulated signals according to one or more example embodiments of the present disclosure.

FIG. 4A is a waveform diagram illustrating a reflected signal according to one or more example embodiments of the present disclosure.

FIG. 4B is a waveform diagram illustrating an inter-wavelet interval of the reflected signal shown in FIG. 4A according to one or more example embodiments of the present disclosure.

FIG. 5 illustrates a block diagram of a monitoring device according to one or more example embodiments of the present disclosure.

FIG. 6 illustrates a biometrics estimation training system according to one or more example embodiments of the present disclosure.

FIGS. 7-9 illustrate flow diagrams of methods of contactless biometric monitoring according to one or more example embodiments of the present disclosure.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated.

Generally, a biometric measuring device may be a contact device that may measure various biometrics of a user while the device (e.g., one or more sensors thereof) is in contact with (or in close proximity to) the user. However, when the user is asleep, taking a shower, or is otherwise not in contact with (or in close proximity to) the biometric measuring device, the biometric measuring device may be unable to accurately measure the biometrics of the user. In other words, because the biometric measuring device may need to be in contact with the user to measure the biometrics of the user, the biometric measuring device may be unsuitable to monitor (e.g., to continuously monitor) the biometrics for changes at any given time, for example, such as when the user is asleep, the device is being charged, or the user is otherwise not in contact with the device.

According to one or more example embodiments of the present disclosure, a contactless biometric monitoring system is provided that may leverage various different kinds of devices and products (e.g., smart devices and products), which may be found throughout many modern homes (e.g., smart homes), to monitor (e.g., to continuously monitor) various biometrics of the user in real-time (or substantially in real-time). For example, the contactless biometric monitoring system may utilize various different kinds of signals (e.g., audio signals, image signals, radio frequency (RF) signals, and/or the like) that are typically generated by these various different kinds of devices, and may accurately measure the biometrics of the user according to reflections of these signals off the user without requiring that the user to be in contact with (or be in close proximity to) the devices.

For example, in some embodiments, the system may include a signal transmitter array to transmit modulated signals (e.g., modulated high frequency signals) towards the person, and a signal receiver array to receive (e.g., to detect) the modulated signals that are reflected off the person. In some embodiments, the transmitter array may include one or more transmitter devices or transmitters, for example, such as a speaker, an RF generator, a time of flight (TOF) sensor, and/or the like, configured to generate the modulated signals. In some embodiments, the receiver array may include one or more receiver devices or receivers, for example, such as a microphone (or a built-in microphone of a device), an RF receiver, and/or the like, configured to receive and/or analyze the modulated signals. For example, in various embodiments, one or more of the receiver devices in the signal receiver array may analyze the received modulated signals to determine a location, an activity, and/or a biometric measurement of the user from reflections in the modulated signals, or may transmit the received modulated signals to another device (e.g., a computing device) for downstream processing.

According to one or more example embodiments of the present disclosure, the system may be an adaptive self-organized monitoring system. For example, in some embodiments, the devices (e.g., in-network devices) that compose the system may be dynamically configured and/or synchronized as needed or desired. In some embodiments, one or more of the devices may be configured as a main device (e.g., a main monitoring device) to establish a communication protocol with other devices located within a measurement area (e.g., a geographical measurement area) according to the kinds of signals (e.g., audio signals, RF signals, and/or the like) that may be transmitted and/or received by the other devices, and to configure (e.g., initialize and calibrate) the other devices to operate as part of the monitoring system (e.g., to activate the device into the monitoring system) as needed or desired according to the established communication protocol. Accordingly, devices may be dynamically added to (or removed from) the monitoring system as needed or desired according to the established communication protocol (e.g., according to the kinds of signals that the devices are capable of transmitting and/or receiving).

According to one or more example embodiments of the present disclosure, machine learning may be leveraged to improve the biometrics measured by the devices of the monitoring system. For example, in some embodiments, a biometric estimation training system may be provided that is communicably connected to a contact device (e.g., a biometric measuring device, for example, such as a smart watch, a fitness tracker, a smart phone, and/or the like) of the user. When the contact device is connected (and in contact with or in close proximity to the user), the training system may leverage the biometric measurements of the contact device to train an optimizer to map an output of the monitoring system to a more accurate set of measurements according to the biometric measurements of the contact device. Accordingly, the monitoring system may be trained to improve or optimize the biometric measurements extracted from the reflected signals according to real-time (or substantially in real-time) biometric measurements of the contact device.

According to one or more example embodiments of the present disclosure, the contactless biometric monitoring system may provide improved biometric monitoring, and may be applied to various use cases and scenarios that may be unsuitable for a contact device. For example, the contactless biometric monitoring system may enable real-time (or substantially in real time) medical adherence by determining the likelihood that the user took his/her medication, may enable continuous or substantially continuous skeletal structure monitoring in real-time (or substantially in real-time), may enable real-time (or substantially in real-time) cardiac health monitoring, may enable monitoring of sleeping conditions in real-time (or substantially in real-time), for example, to determine abnormal sleeping patterns (e.g., to prevent sudden infant death syndrome, detect sleep apnea, and/or the like), may enable monitoring of various health-related events (e.g., fall detection, stroke detection, and/or the like) in real-time (or substantially in real-time), and/or the like, without requiring that the user be continuously in contact with a contact device.

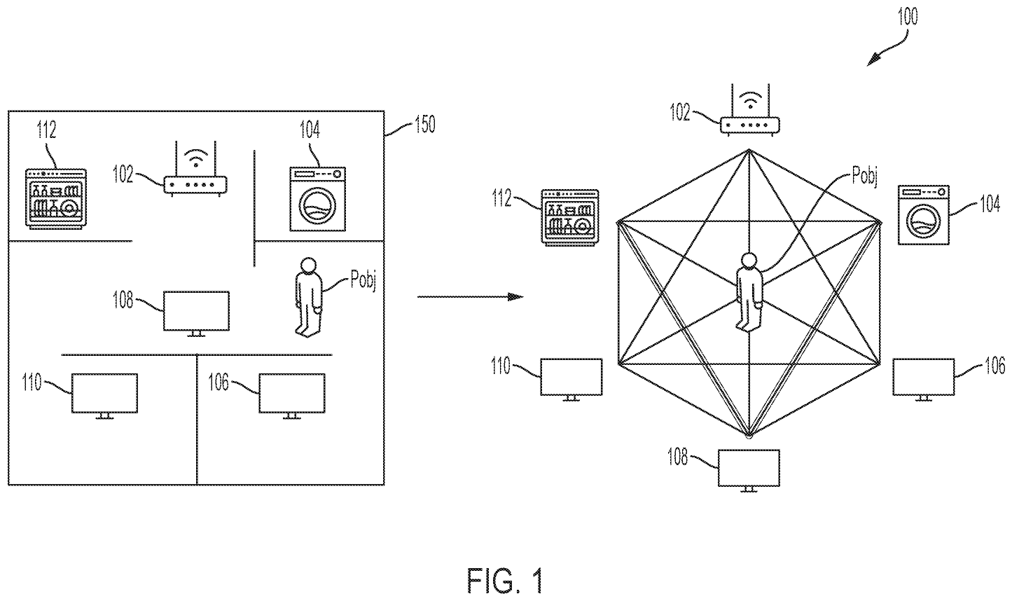

FIG. 1 illustrates a contactless biometric monitoring system according to one or more example embodiments of the present disclosure.

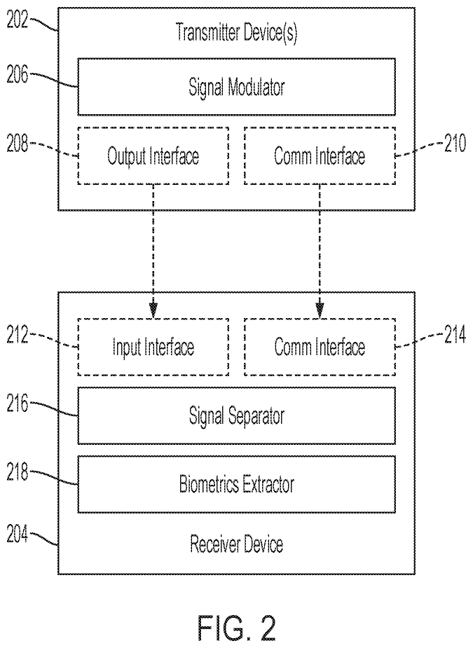

Referring to FIG. 1, a contactless biometric monitoring system 100 may include an array of a plurality of devices 102 to 112 that are located within an environment 150. The environment 150 may be any suitable space in which the devices 102 to 112 are arranged, and may include, for example, a building, a floor of a building, a room, a zone, a space, and/or the like. The space need not be physically enclosed. For example, the space may include an outdoor area. Each of the plurality of devices 102 to 112 may be a transmitter device, a receiver device, and/or a transmitter/receiver device, and thus, may include one or more transmitters and/or one or more receivers. For example, in some embodiments, the devices 102 to 112 may include at least one transmitter device and at least one receiver device (e.g., see FIG. 2). In another example, in some embodiments, the devices 102 to 112 may include at least one transmitter/receiver device (e.g., a device that functions as both a transmitter device and a receiver device). In still another example, in some embodiments, the devices 102 to 112 may include a combination of one or more transmitter devices, one or more receiver devices, and one or more transmitter/receiver devices.

As used herein, a transmitter device may be a device that emits a signal (e.g., a modulated signal) into the environment 150 that is modulated such that a reflection of the signal off one or more persons (e.g., the person Pobj) located within the environment 150 indicates some desired biometric information, a receiver device may be a device that receives a reflected signal (e.g., corresponding to the modulated signal) reflected by the one or more persons located in the environment 150, and a transmitter/receiver device is a device that may both transmit the signals and receive the reflected signals. In this context, the signal may be any suitable kind of signal, such as an audio signal (e.g., an audible sound, ultrasound, and/or the like), an optical signal (e.g., visible light, infrared, and/or the like), a radio frequency (RF) signal (e.g., an RF signal carrying data according to an (Institute of Electrical and Electronics Engineers) IEEE 802.11 protocol, an RF signal carrying data according to a Bluetooth® protocol, and/or the like (Bluetooth is a registered trademark of Bluetooth SIG, Inc. of Kirkland, Wash.)), and/or the like, that is modulated such that a reflection of the modulated signal indicates various kinds of vibrations (e.g., body vibrations) off the one or more persons located in the environment. For example, transmitting devices may generate different modulated signals from each other, such that reflections of the different modulation signals amplify different body vibrations (e.g., respiratory, heartbeat, and/or the like), and/or the transmitting devices may generate the same or substantially the same modulated signal but with different phase shifts from each other, such that the relative phase shifts information include both slow (e.g., respiratory rate) and fast (e.g., heart rate) changing biometrics patterns.

Accordingly, in various embodiments, each of the devices 102 to 112 may be any one of a transmitter device, such as a speaker, a Bluetooth headset, a television, an RF generator, a time of flight (TOF) sensor, and/or the like configured to transmit modulated signals (e.g., modulated audio signals, modulated optical signals, modulated RF signals, and/or the like) into the environment 150; a receiver device, such as a microphone, an RF receiver, a camera, a 3D sensor, and/or the like configured to receive (or to detect) the modulated signals that are reflected off objects in the environment 150; and/or a transmitter/receiver device, such as a smart phone, a smart phone headset, a smart speaker, a tablet, a personal computer, a laptop computer, a smart hub (e.g., an IoT device hub), a wireless router, a smart watch, a fitness tracker, and/or the like configured to both transmit and receive the modulated signals. However, the present disclosure is not limited to the examples described above, and each of the devices 102 to 112 may include any suitable device that may transmit and/or receive modulated signals, for example, such as any suitable network device, smart device, smart appliance (e.g., smart refrigerator, smart washer/dryer, smart thermostat, and/or the like), Internet of Things (IoT) device, and/or the like.

As a non-limiting example, in some embodiments, the biometric monitoring system 100 may include in-ear headphones as transmitting devices, and a built-in microphone of the in-ear headphones as a receiving device. In this case, the speakers of the headphones may generate modulated audio signals (e.g., audible sound, ultrasound, and/or the like) toward a person's location, and the built-in microphone of the headphones may collect reflected signals (e.g., reflected body vibration signals) corresponding to the modulated audio signals that are reflected off the person. A location, an activity, a biometric, and/or the like of the person may be identified from the reflected signals. In another non-limiting example, in some embodiments, the biometric monitoring system 100 may trigger a nearby microphone (e.g., a built-in microphone of a nearby device, for example, such as a smart phone) as needed or desired to collect additional reflected signals concurrently (e.g., simultaneously or at the same time) with those collected by the built-in microphone of the in-ear headphones.

In some embodiments, different transmitting devices may transmit different kinds of signals (e.g., different kinds of source signals) from each other. For example, one transmitting device may transmit an audio signal, and another transmitting device may transmit an RF signal. In this case, the system may include one or more receiver devices (or receiver/transmitter devices) capable of receiving (or detecting) the different kinds of signals. However, the present disclosure is not limited thereto, and the system may include at least one transmitter device to transmit a suitable modulated signal into the environment 150, and the one transmitter device may transmit the same kind of signals (e.g., source signals) as those of each of the other transmitter devices or may transmit a different kind of signal from that of at least one of the other transmitter devices.

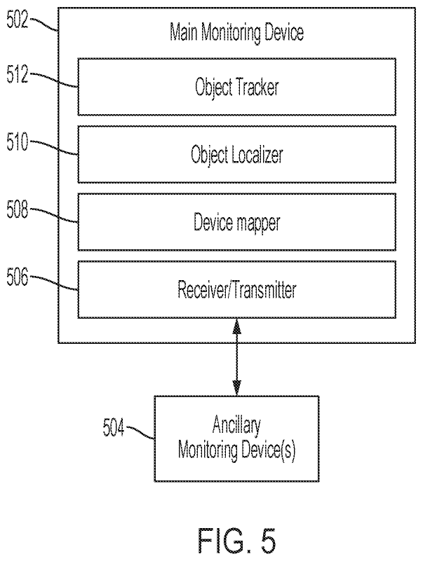

In some embodiments, at least one of the devices 102 to 112 may be a monitoring device (e.g., see FIG. 5). The monitoring device may dynamically configure (e.g., initialize and/or calibrate) one or more other devices located within a desired area (e.g., located within a measurement area of the environment 150) into the system 100 as needed or desired. The monitoring device may be configured as a transmitter device, a receiver device, or a transmitter/receiver device, and may include at least one transmitter and at least one receiver. For example, the monitoring device may establish a communication protocol with the devices located within the desired area using RF signals, audio signals, and/or the like, and may initialize a monitoring function and/or signal synchronization between the devices using the established communication protocol. In some embodiments, the monitoring device may switch between various different kinds of monitoring modes, for example, according to detected user activity and/or trained user behavior. Accordingly, devices may be triggered and/or synchronized into the system 100 as needed or desired to monitor various biometrics of the user (e.g., the person Pobj).

According to one or more example embodiments of the present disclosure, at least one of the devices 102 to 112 may be a computing device (e.g., a computer, a smart phone, a smart speaker, a smart watch, a tablet, a smart hub, and/or the like). The computing device may be a device including at least a processor and memory to analyze (e.g., to extract, estimate, and/or the like) the desired information (e.g., user location, user activity, user biometrics, and/or the like) from reflections in the received signals. Thus, the computing device may be a receiver device, a receiver/transmitter device, a monitoring device, and/or the like, and one or more of the devices 102 to 112 located within the environment 150 may be a computing device. However, the present disclosure is not limited thereto, and the computing device may be a device that is located externally from the environment 150. For example, in some embodiments, the computing device may be a remote centralized server that is communicably connected to at least one of the devices 102 to 112 located in the environment 150 to analyze the reflected signals detected from the environment 150.

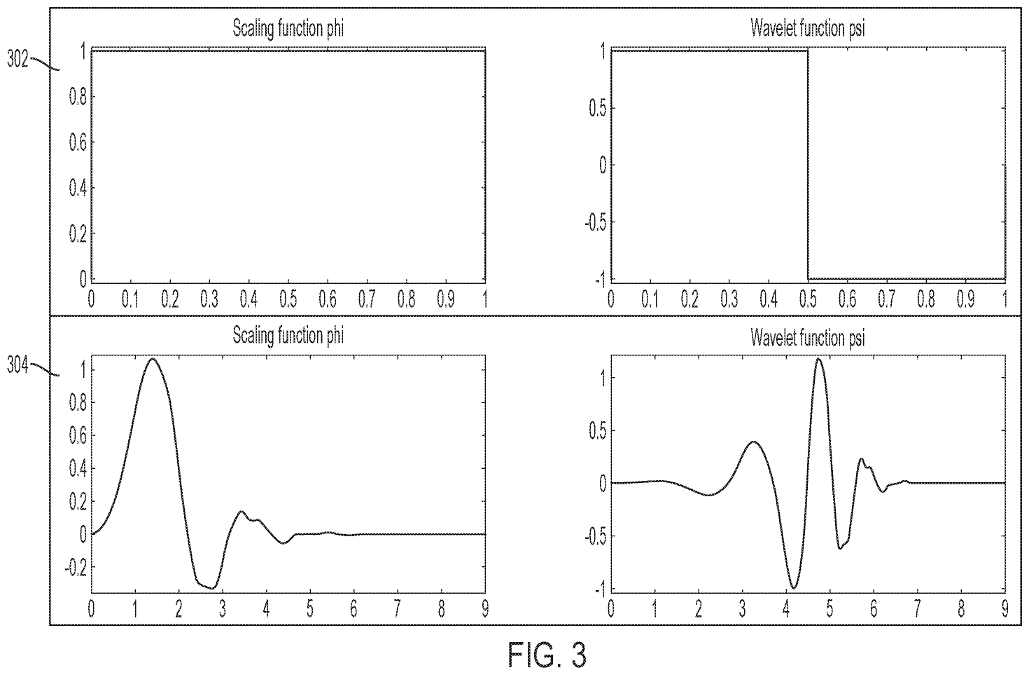

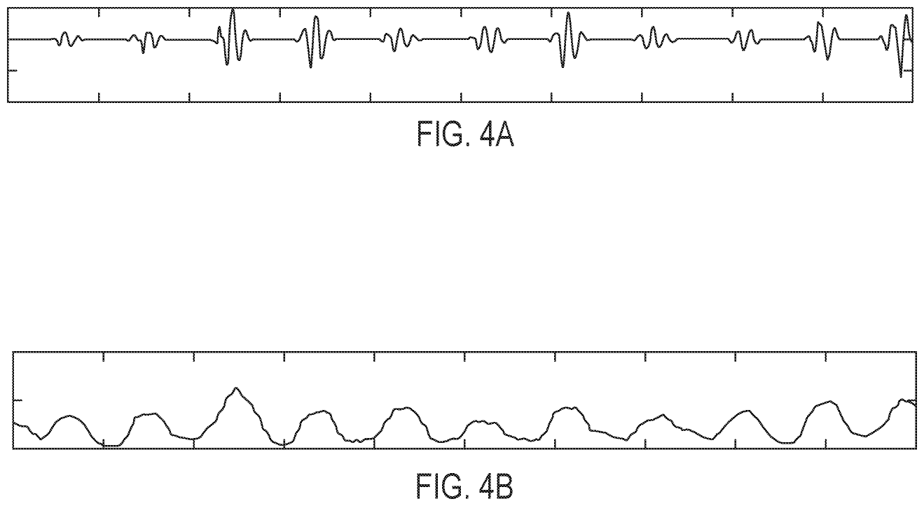

FIG. 2 illustrates a block diagram of a receiver device and a transmitter device according to one or more example embodiments of the present disclosure. FIG. 3 illustrates waveform diagrams of various examples of different modulated signals according to one or more example embodiments of the present disclosure. FIG. 4A is a waveform diagram illustrating a reflected signal according to one or more example embodiments of the present disclosure. FIG. 4B is a waveform diagram illustrating an inter-wavelet interval of the reflected signal shown in FIG. 4A according to one or more example embodiments of the present disclosure.

Referring to FIGS. 1 through 4B, in some embodiments, the biometric monitoring system 100 may include at least one transmitter device 202, and at least one receiver device 204. The transmitter device 202 may include a signal modulator 206 to generate a modulated signal, and at least one of an output interface 208 or a communication interface 210 to emit the modulated signal into the environment 150. For example, if the transmitter device 204 is a speaker, the signal modulator 206 may modulate an input audio data signal to generate a modulated audio signal, and the modulated audio signal may be emitted into the environment 150 via the output interface 208, for example, such as an audio emitter (e.g., the speaker). In another example, if the transmitter device 204 is an RF generator, the signal modulator 206 may modulate an input RF signal to generate a modulated RF signal, and the modulated RF signal may be emitted into the environment 150 via the communication interface 210, for example, such as an RF emitter. While various different modulation techniques are described in more detail below, the present disclosure is not limited thereto, and any suitable modulation technique may be used to enhance various different biometrics of the person Pobj as needed or desired. In various embodiments, the signal modulator 206 may be implemented in hardware (e.g., as a circuit or an integrated circuit including a plurality of logic components (e.g., logic gates, flip-flops, shift registers, and/or the like)), and/or may be implemented in software or firmware, for example, as a processor executing instructions stored in memory.

In some embodiments, the signals generated from two different transmitter devices 202 may be the same or substantially the same as each other, but with different phase shifts or with different modulations from each other. For example, referring again to the non-limiting example of the in-ear headphones discussed above, the signals (e.g., audio signals) emitted from the two headphone speakers (e.g., a left speaker and a right speaker) may have different modulations from each other. In this case, for example, a first speaker of the in-ear headphones may generate a first modulated signal (e.g., a first audio signal) including high frequency range components, and a second speaker of the in-ear headphones may generate a second modulated signal (e.g., a second audio signal) having low frequency range components. For example, in some embodiments, various different modulations may amplify different kinds of body vibrations such that different biometrics may be monitored, and in some embodiments, may be used to detect multi-subject (e.g., multi-persons) biometrics. Thus, in this example, the built in microphone may receive reflected signals corresponding to a mix of the first and second modulated signals reflecting off the person Pobj, and may extract various biometrics information therefrom, for example, according to the different modulations of the signals, as discussed further below.

In some embodiments, different modulated/frequency band signals may be transmitted by a one or more of the transmitter devices 202 so that one or more of the receiver devices 204 may quantify, based on reflections of the different modulated/frequency band signals, values of mass attenuation coefficients from surface absorptions and scattering to accurately extract desired biometrics information. Some examples of different wavelets are shown in FIG. 3 that may be used by the signal modulator 206 to modulate the signals generated by one or more of the transmitter devices 202, such that different kinds of physiological signals from one or more persons in the environment 150 may be amplified in reflections of the modulated signals off the one or more persons, but the present disclosure is not limited to the modulations shown in FIG. 3.

As shown in FIG. 3, an upper wavelet 302 (e.g., a “Haar” wavelet) may be used to detect sudden baseline changes (e.g., motion, muscle contraction, and/or the like), and a lower wavelet 304 (e.g., a “Daubechies wavelet 5”) may be used to detect heart beat vibrations (e.g., ballistocardioprahy (BCG)). In this example, the signals generated by the transmitter devices 202 may be modulated with at least one of the upper wavelet 302 or the lower wavelet 304 according to the desired biometric information (e.g., changes in body position, respiration rate, heart rate, and/or the like) to be measured by the system, such that the desired biometric information may be estimated (e.g., extracted) from one or more reflections of the modulated signals off one or more persons in the environment 150 and received by one or more receiver devices 204.

As another example, in some embodiments, signals generated from two different transmitter devices 202 may have the same or substantially the same modulation as each other, but with different phase shifts from each other, such that the relative phase shifts information of the signals may include both slow and fast changing biometrics patterns. In this case, slow-changing direct-current (DC) information (e.g., such as respiratory trend) in the reflected signal may be extracted using, for example, a low-pass filter, and fast-changing DC information (e.g., such as cardiac rhythm) in the reflected signal may be extracted using, for example, a band-pass filter.

The receiver device 204 may receive (e.g., may detect) the modulated signals, reflections of the modulated signals, or a combination thereof from the environment 150. For example, in some embodiments, the receiver device 204 may receive (e.g., may detect) the modulated signals that are reflected off one or more objects (e.g., the person Pobj) located within the environment 150. Accordingly, in some embodiments, the receiver device 204 may include any suitable interface to receive (e.g., to detect) at least the modulated signals. For example, if the transmitting device 202 is a speaker that transmits modulated audio signals, the receiver device 204 may include at least an input interface 212, for example, such as a microphone, to detect the modulated audio signals. In another example, if the transmitting device 202 is an RF generator that transmits modulated RF signals, the receiver device 204 may include at least a suitable communications interface 214, for example, such as an RF receiver, to detect the modulated RF signals.

In various embodiments, the output interface 208 of the transmitter device 202 may include any suitable output device or sensor, for example, such as a speaker, a display screen, a TOF sensor, and/or the like, to transmit the modulated signals into the environment 150, and the input interface 212 of the receiver device 204 may include any suitable input device or sensor corresponding to the output device or sensor of the transmitter device 202, for example, such as a microphone, a light sensor, an image sensor, a 3D sensor, and/or the like, to receive (e.g., to detect) the modulated signals from the environment 150. In various embodiments, the communication interfaces 210 and/or 214 may include any suitable wired or wireless communications interfaces (e.g., jacks, antennas, transmitters, receivers, transceivers, wire terminals, and/or the like) to transmit and/or receive the modulated signals. In various embodiments, the modulated signals transmitted and/or received by the communication interfaces 210 and 214 may be direct (e.g., via local wired or wireless communications) or via a communications network (e.g., a WAN, the Internet, a cellular network, and/or the like). For example, the communication interfaces 210 and 214 may include a Wi-Fi transmitter, receiver, and/or transceiver, a Bluetooth transmitter, receiver, and/or transceiver, an Ethernet card and port, cellular or mobile phone communications transmitters, receivers, and/or transceivers, and/or the like.

In some embodiments, as shown in FIG. 2, the receiver device 204 may include a signal separator 216. The signal separator 216 may separate the received signal to isolate a reflection signal from a modulation of the received signal. For example, if multiple transmitters 202 and/or receivers 204 are in the system, the modulated signals transmitted to the environment 150 may be mixed with each other and/or with other signals (e.g., reflection signals or reflected signals) as a mixed signal or a hybrid signal, and in this case, the signal separator 216 may separate independent inputs and/or the reflected signals from the received signal. In various embodiments, the signal separator 216 may be implemented in software or firmware (e.g., via a processor executing instructions in memory), and/or may be implemented in hardware (e.g., as a circuit or an integrated circuit including a plurality of logic components (e.g., logic gates), filters (e.g., low-pass filters, bandpass filters, and/or the like) circuit components (e.g., resistors, transistors, capacitors, and/or the like), and/or the like).

As a non-limiting example, if the system includes multiple transmitter devices 202 and one receiver device 204, because the dimension of the mixed signal is smaller than the dimension of the source signals, the signal separator 216 may use a nonlinear approach (e.g., a nonlinear algorithm, method, and/or the like) to separate output.

However, because each of the signal modulations may be known (e.g., may be determined), in some embodiments, the signal separator 216 may convolve the modulations with mixed output to extract each reflected signal. In another non-limiting example, if multiple transmitters 202 and multiple receivers 204 are in the system, and a number of receivers 204 is greater than a number of transmitters 202, the signal separator 216 may use any suitable linear approach (e.g., a linear algorithm, method, and/or the like), for example, such as independent component analysis, to separate overdetermined sources.

In some embodiments, the receiver device 204 may be configured as a pass-through device that forwards (e.g., re-transmits) the received reflections of the modulated signals, the received modulated signals, or a combination thereof to another device (e.g., a computing device) for downstream processing. In this case, the receiver device 204 may transmit the reflections, the modulated signals, or a combination thereof to the computing device in the same or substantially the same format received, or may include a converter (e.g., an analog to digital converter) to first convert the modulated signals from a 1st format (e.g., the received format) to a second format (e.g., a digital format or other suitable format) for transmission to the computing device. The computing device may include at least a biometrics extractor 218 to analyze the received modulated signals, reflections, or a combination thereof to determine (e.g., to estimate, extract, and/or the like) the desired biometrics information from the reflections. In other embodiments, the receiver device 204 may be configured as a computing device including at least the biometrics extractor 218, such that the receiver device 204 may directly analyze the received signals to determine the desired biometrics information. For example, the biometrics extractor 218 may be implemented via a processor executing instructions stored in memory.

For convenience, FIG. 2 illustrates that the receiver device 204 is implemented as a computing device including at least the biometrics extractor 218, but the present disclosure is not limited thereto, and any one or more of the devices 102 to 112 in the environment 150 may be implemented as a computing device including the biometrics extractor 218, or the biometrics extractor 218 may be implemented as an external device (e.g., a centralized server) that is communicably connected to at least one of the devices 102 to 112 in the environment 150 to receive signals reflected off objects in the environment 150. For example, the computing device may include a processing circuit including one or more processors and memory, and the biometrics extractor 218 may be implemented as computer code stored in the memory and executed by the processor to analyze the reflections.

In some embodiments, the biometrics extractor 218 may analyze the separated signals to determine reflected wavelet locations in the separated signals. Each separated signal may correspond to a reflection of a modulated signal transmitted by one of the transmitter devices 202 and received by the receiver device 204. In a non-limiting example assuming a single transmitter device 202 and a single receiver device 204, signal traveling distance/time (e.g., time of flight) may be calculated from correlation or convolution. For example, FIG. 4A illustrates an example of a reflected signal received by the receiver device 204, where the reflected signal is a reflection of a signal transmitted by the transmitter device 202 and modulated according to the lower wavelet 304 shown in FIG. 3. In some embodiments, the biometrics extractor 218 may determine the reflected wavelet locations (e.g., extracted event locations) in the reflected signal by applying a convolution to the reflected signal. For example, when the transmitted modulated signal reaches a reflection surface (e.g., the human body), the modulated signal indicates salient morphological characteristics. By convolving the wavelet (e.g., the lower wavelet 304) with the reflected signal, locations where the reflections occur may be identified. The biometrics extractor 218 may calculate inter-wavelet intervals from the extracted locations, for example, as shown in FIG. 4B. For example, FIG. 4B shows a continuous respiratory signal extracted from the inter-wavelet intervals calculation of the reflected signal shown in FIG. 4A. The inter-wavelet interval may correspond to the convolution result. For example, the inter-wavelet interval indicates detected events interval (which are shown in FIG. 4B in intervals of 2 respiratory events as a non-limiting example).

In some embodiments, the biometrics extractor 218 may calculate amplitude envelops of the reflected signal to track relatively slow changes in the system. For example, in some embodiments, the biometrics extractor 218 may extract respiratory signals from the amplitude envelops of the reflected signal shown in FIG. 4A. Referring to FIG. 4A, the amplitude envelope may correspond to a contour of a maximum/minimum signal amplitude. For example, similar to Herbert transform, the amplitude envelope may be a low frequency signal that reflects slow changes in the system, such as respiratory signals. In some embodiments, a plurality of receiver devices 204 may be arranged within the environment 150, and may capture (e.g., may detect) a mixed signal including multiple persons' biometrics within the environment 150. In this case, in some embodiments, due to localization differences of different receiver devices 204 arranged throughout the environment 150, independent component analysis, blind signal separation, and/or any other suitable signal separation method may be used to efficiently isolate the individuals' biometrics.

In some embodiments, two of the transmitter devices 202 transmit the same or substantially the same modulated signals but with different phase shifts from each other, the biometrics extractor 218 may apply a low-pass filter to the received reflected signal to extract respiratory signals or other slow-changing DC information in the reflected signal, and may apply a band-pass filter with a frequency range of cardiac rhythm to extract heart beat information or other fast changing DC information in the reflected signal. In some embodiments, the biometrics extractor 218 may apply various suitable signal processing techniques to separate the received signals and/or to extract the desired biometrics information from the received signals, for example, such as energy entropy reconstruction, time delay embedding, and/or the like as described in U.S. patent application Ser. Nos. 15/726,756, 15/168,531, and 15/264,333, which are incorporated by reference herein in their entirety.

FIG. 5 illustrates a block diagram of a monitoring device according to one or more example embodiments of the present disclosure.

Referring to FIGS. 1 through 5, in some embodiments, the biometrics monitoring system 100 may be an adaptive self-organized monitoring system. For example, in some embodiments, the biometrics monitoring system 100 may include at least one monitoring device 502 from among the one or more devices 102 to 112 located within the environment 150. The monitoring device 502 may establish a communication protocol with the other devices 102 to 112 located within the environment 150 according to the kinds of signals transmitted and/or received by the other devices 102 to 112, and may configure (e.g., may initialize and/or may calibrate) the other devices 102 to 112 into the system 100 as needed or desired according to the established communication protocol. For example, the monitoring device may use audio signals, RF signals, and/or the like to establish a suitable communications protocol with one or more of the other devices 102 to 112 according to the kinds of signals that the one or more other devices 102 to 112 are capable of receiving/transmitting, and may configure the one or more other devices 102 to 112 into the monitoring system 100 as needed or desired according to the established communication protocol therebetween.

For example, as shown in FIG. 5, a main monitoring device 502 may trigger one or more ancillary monitoring devices 504 located within the environment 150 as needed or desired (e.g., as a person Pobj moves through the environment 150), to transmit and/or receive (e.g., to detect) the modulated signals reflecting off objects located in the environment 150. Each of the main monitoring device 502 and the one or more ancillary monitoring devices 504 may correspond to the devices 102 to 112 that are located within the environment 150, and may be any suitable one of a transmitter device, a receiver device, or a transmitter/receiver device as described above. For example, in some embodiments, the main monitoring device 502 may transmit a modulated initialization signal into the environment 150, and one or more of the ancillary monitoring devices 504 may capture (or may detect) the modulated initialization signal. The modulated initialization signal may be an audio signal, an RF signal, and/or the like. The ancillary monitoring devices 504 that capture (e.g., that detect or receive) the modulated initialization signal may transmit a response if a signal strength of the captured initialization signal is greater than a threshold signal strength (e.g., a predetermined signal strength), and connection (e.g., a communication protocol) between the main monitoring device 502 and the one or more ancillary monitoring devices 504 may be established according to the responses received by the main monitoring device 502.

For example, in some embodiments, each of the main monitoring device 502 and the ancillary monitoring devices 504 may include at least one receiver and at least one transmitter (e.g., a receiver/transmitter 506). The receiver may be the same or substantially the same as the receiver device 204 described above with reference to FIG. 2, or may be different therefrom depending on a configuration of the device (e.g., as a receiver device, a transmitter device, or a receiver/transmitter device). The transmitter may be the same or substantially the same as the transmitter device 202 described above with reference to FIG. 2, or may be different therefrom depending on the configuration of the device. For example, while each of the monitoring devices 502 and 504 includes both a transmitter and a receiver, each of the monitoring devices 502 and 504 may be configured as a transmitter device to transmit the modulated signals, a receiver device to receive the reflected signals, or a transmitter/receiver device to both transmit the modulated signals and to receive the reflected signals. In other embodiments, one or more of the monitoring devices 502 and 504 may be configured to perform only one or more of the monitoring functions (e.g., device initialization and configuration, object localization, object tracking, monitoring mode switching, and/or the like) described herein.

In some embodiments, to initialize a monitoring function or signal synchronization, the transmitter of the main monitoring device 502 may transmit the modulated initialization signal into the environment 150. The receivers of the ancillary monitoring devices 504 that detect the modulated initialization signal from the environment 150 may compare a signal strength of the detected modulated initialization signal with the threshold signal strength, and the ancillary monitoring devices 504 may transmit a response if the signal strength is greater than the threshold signal strength. The main monitoring device 502 may establish the communication protocol with those ancillary monitoring devices 504 that transmit the response.

In some embodiments, a geographic distance mapping of the devices that are activated into the system 100 (e.g., in network devices) may be generated. For example, in some embodiments, the main monitoring device 502 (or each of the monitoring devices 502 and 504) may include a device mapper 508. The device mapper 508 may be implemented via a processor executing instructions stored in memory. In some embodiments, after the connection is established between the main monitoring device 502 and the ancillary monitoring devices 504, the devices that are in network may emit a calibration modulated signal to each other, and the device mapper 508 may generate the geographic distance mapping between the in network devices according to the calibration modulated signals. In some embodiments, the geographic distance mapping may be used to calibrate and configure device parameters of the in network devices. In some embodiments, the geographic distance mapping may be used to determine a location of each of the in network devices within the environment 150.

In some embodiments, the main monitoring device 502 (or each of the monitoring devices 502 and 504) may include an object localizer 510 to generate real-time (or substantially in real-time) energy distribution map of a measurement area. The object localizer 510 may be implemented via a processor executing instructions stored in memory. The energy distribution map may be used to determine locations of objects (e.g., persons) within the environment 150. In some embodiments, the object localizer 510 may calculate the energy distribution (e.g., the energy distribution map) according to global signal standard deviation. For example, if signal variation of the measurement area of the geographic distance mapping is continuously higher (e.g., significantly higher) than an adjacent area, the object localizer 510 may determine that the measurement area includes moving objects. In some embodiments, the system 100 may determine whether the moving object is alive (e.g., is a person) according to the reflected signals analyzed from the environment 150 as discussed above (e.g., whether or not the object reflects biometrics information as discussed above).

In some embodiments, the main monitoring device 502 (or each of the monitoring devices 502 and 504) may include an object tracker 512 to track a location of the moving object as the moving object moves throughout the environment 150. The object tracker 512 may be implemented via a processor executing instructions stored in memory. For example, in some embodiments, the main monitoring device 502 may actively transmit encoded communications requests into the environment 150 near where the moving object is detected, and based on feedback from devices located near the moving object, may dynamically adjust (or establish) an energy map of the nearby area (e.g., a measurement area). In this case, the main monitoring device 502 may include a smart phone, a smart speaker, a smart watch, and/or the like. In some embodiments, the object tracker 512 may use the energy map to update a location of the moving object. In some embodiments, the object tracker 512 may detect an activity (e.g., walking, sleeping, reading, exercising, eating, and/or the like) and/or a potential identity (e.g., based on biometric readings) of the moving object according to trained user behavior (e.g., according to historical user data).

In some embodiments, the object tracker 512 may switch to different monitoring modes according to the user activity (or modes of other ancillary devices) detected by the system 100. For example, if the main monitoring device 502 is a smart phone, the main monitoring device 502 may detect that the other in network devices initialized into the system 100 were previously used to monitor sleep mode, and the main monitoring device 502 may automatically trigger sleep monitoring mode (e.g., trigger respiration rate monitoring, heartbeat monitoring, and/or the like). To identify/switch between various monitoring modes, the object tracker 512 may use any suitable methods or algorithms, for example, such as Bayesian identification, classification methods (e.g., support vector machine), logistic regression, deep learning methods (e.g., LSTM with softmax as activation function at output layer) and/or the like. Some other inputs that may be considered by the object tracker 512 to identify/switch between modes may include, for example, identifications of nearby devices, activity within the energy map, user behavior, locations of the moving objects, and/or the like.

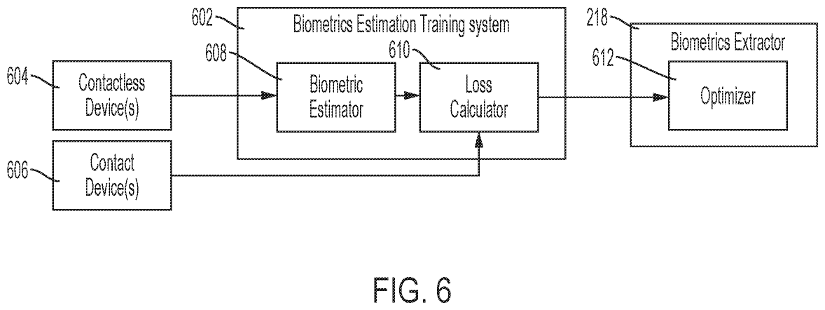

FIG. 6 illustrates a biometrics estimation training system according to one or more example embodiments of the present disclosure.

In some embodiments, the biometrics estimation training system 602 may utilize machine learning (e.g., supervised learning) to train the monitoring system 100 to improve the biometrics estimations from the reflections in the received signals. For example, in some embodiments, the training system 602 may be communicably connected to the biometrics extractor 218, and the biometrics extractor 218 may include an optimizer that is trained by the training system 602 to generate (e.g., to map) the biometrics estimated by the monitoring system 100 to a more accurate set of biometric measurements based on real-time (or substantially in real-time) training data (e.g., ground-truth and labels). In this case, the training data (e.g., the ground-truth and labels) may be received from a contact device 606 (e.g., a smart watch, a fitness tracker, a smart phone, and/or the like) when the contact device 606 is connected to the training system 602. For example, when the contact device 606 is connected to the training system 602 (and in contact with the user), the contact device 606 may transmit real-time (or substantially in real-time) biometric measurements of the user, which may be used as the training data to train the system 100.

For example, in some embodiments, the training system 602 may include any suitable neural network (e.g., a convoluted neural network (CNN), a recursive neural network (RNN), and/or the like), that may be trained based on the results of the monitoring system 100 and the training data received by the contact device 606. For example, in some embodiments, the training system 602 may include a biometric estimator 608 and a loss calculator 610, which may be implemented as a processor executing instructions stored in memory. In some embodiments, the biometric estimator 608 may receive the reflected signals detected from one or more of the devices (e.g., the contactless devices 604) in the monitoring system 100, and may estimate the biometrics information from the reflections in the reflected signal as discussed above. However, the present disclosure is not limited thereto, and in other embodiments, the training system 602 (e.g., the loss calculator 610) may receive the estimated biometrics information directly from one or more devices (e.g., one or more of the contactless devices 604) in the system 100, and in this case, the biometrics estimator 608 may be omitted. The loss calculator 610 may receive the biometrics measurements of the contact device 606, and may calculate a loss function between the estimated biometrics information and the biometrics measurements of the contact device 606.

In some embodiments, the estimated biometrics information may be optimized by minimizing the loss between the estimated biometrics information of the system 100 and the biometrics measurements of the contact device 606. Accordingly, in some embodiments, the optimizer 612 may minimize the loss between the estimated biometrics information and the biometrics measurements of the contact device 606 to improve or optimize the biometrics information estimated by the biometrics extractor 218. For example, the optimizer 612 may be implemented as a processor executing instructions stored in memory.

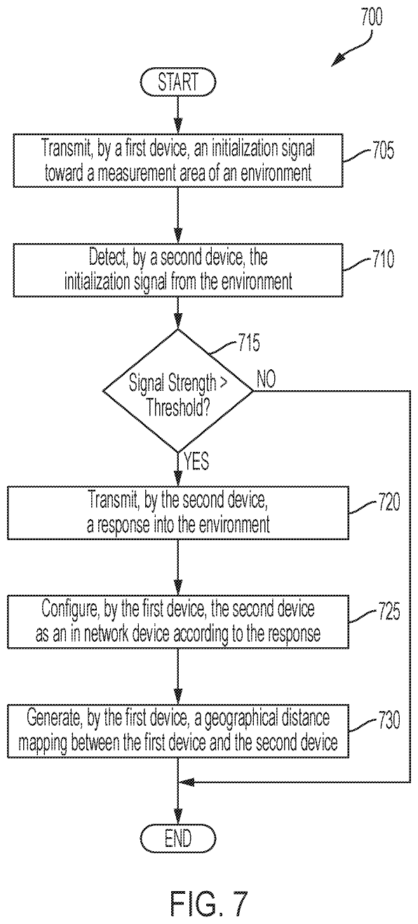

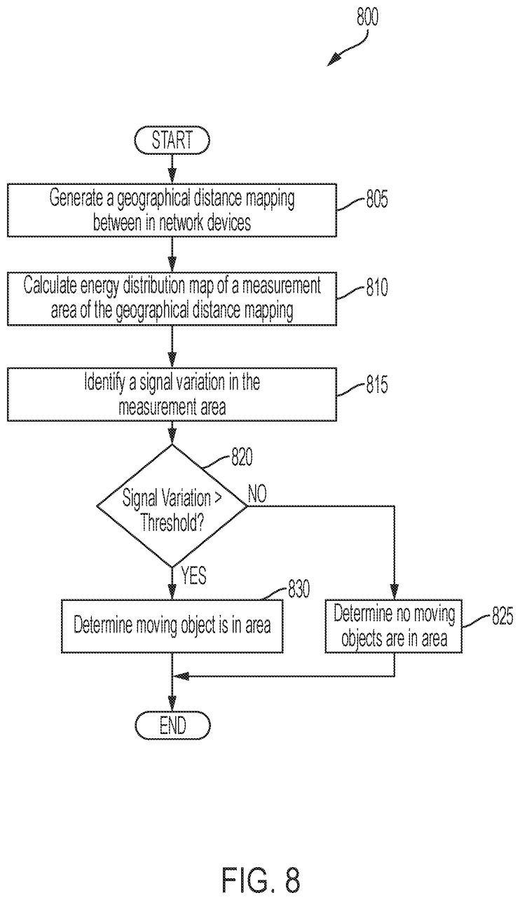

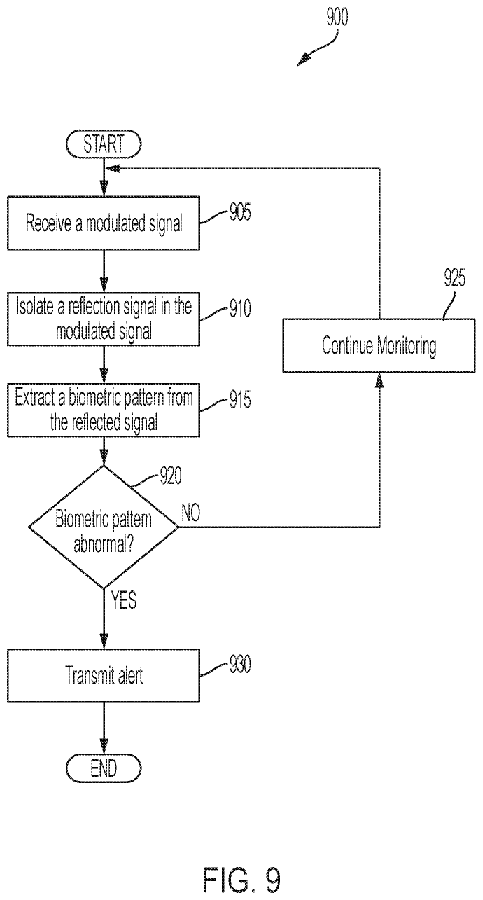

FIGS. 7-9 illustrate flow diagrams of methods of contactless biometric monitoring according to one or more example embodiments of the present disclosure. FIG. 7 illustrates a method 700 of configuring one or more devices into the monitoring system 100. FIG. 8 illustrates a method 800 of identifying one or more moving objects in a measurement area of the monitoring system 100. FIG. 9 illustrates a method 900 of monitoring the biometrics of a user using one or more contactless devices of the monitoring system 100.

The present disclosure is not limited to the sequence or number of the operations of the methods shown in FIGS. 7-9, and can be altered into any desired sequence or number of operations as recognized by a person having ordinary skill in the art. For example, in some embodiments, the order may vary, or the methods may include fewer or additional operations. Further, the operations shown in the methods of FIGS. 7-9 may be performed by any suitable one of the components or any suitable combination of the components of those of one or more example embodiments described above.

Referring to FIG. 7, the method 700 may start, and in some embodiments, a first device may transmit an initialization signal toward a measurement area of an environment at block 705. For example, in some embodiments, the initialization signal may be a modulated initialization signal, and may include an audio signal, an RF signal, and/or the like. A second device may detect (e.g., may receive) the initialization signal from the environment at block 710. For example, in some embodiments, the second device may be a device that is located within a suitable range of the measurement area, such that the second device may detect the modulated initialization signal from the environment. In some embodiments, each of the first device and the second device may be configured as any suitable one of a transmitting device, a receiving device, and/or a transmitting/receiving device to transmit and/or receive suitable kinds of signals that have been modulated to reflect biometric information off one or more persons located within the environment, and each of the first device and the second device may be configured as a monitoring device including at least one receiver and at least one transmitter to activate and configure other devices into the monitoring system 100 as needed or desired.

In some embodiments, the second device may determine whether a signal strength of the modulated initialization signal is greater than a threshold signal strength at block 715. For example, in some embodiments, because the modulated initialization signal may be detected from the environment, the second device may determine whether the second device is a target device (e.g., a device within a suitable range of the relevant measurement area) or if the second device erroneously detected the initialization signal. Accordingly, in some embodiments, the second device may compare the signal strength of the received initialization signal with the threshold signal strength to determine whether the second device is the target device. For example, if the signal strength is less than the threshold signal strength (e.g., NO at block 715), the second device may determine that the second device is not a target device, and the method 700 may end.

On the other hand, if the signal strength is greater than the threshold signal strength (e.g., YES at block 715), the second device may transmit a response into the environment at block 720. The first device may receive the response from the environment, and may configure the second device as an in network device (e.g., as an active device in the monitoring system 100) according to the response at block 725. The first device may then generate a geographical distance mapping between the first device and the second device at block 730. For example, in some embodiments, the first and second devices may transmit modulated calibration signals to each other, and the geographical distance mapping may be generated according to the modulated calibration signals. After the geographical distance mapping is generated between the first device and the second device at block 730, the method 700 may end or may continue with the method 800 shown in FIG. 8 or the method 900 shown in FIG. 9.

Referring to FIG. 8, the method 800 may start, and a geographical distance mapping may be generated between in network devices (e.g., active devices) of the system 100 at block 805. For example, the geographical distance mapping may be generated between the in network devices according to the method 700 shown in FIG. 7. In some embodiments, an energy distribution map of a measurement area of the geographical distance mapping may be calculated at block 810. For example, in some embodiments, the energy distribution of the measurement area may be calculated according to global signal standard deviation as discussed above.

In some embodiments, a signal variation in the measurement area may be identified at block 815, and a determination may be made as to whether the signal variation is greater than a threshold variation at block 820. For example, if signal variation in the measurement area is continuously higher (e.g., substantially higher) than nearby areas, the system may determine that the measurement area includes moving objects. Accordingly, if the signal variation is less than the threshold variation (e.g., NO at block 820), the system 100 may determine that no moving objects are located within the measurement area at block 825, and the method 800 may end. On the other hand, if the signal variation is greater than the threshold variation (e.g., YES at block 820), the system 100 may determine that there are moving objects located within the measurement area at block 830. After determining that there are moving objects in the measurement area at block 830, the method 800 may end or may continue with the method 700 shown in FIG. 7 (e.g., to activate one or more additional devices in the measurement area), or may continue with the method 900 shown in FIG. 9 (e.g., to determine biometric information, if any, of the moving objects in the measurement area).

Referring to FIG. 9, the method 900 may start, and a modulated signal may be received at block 905. For example, in some embodiments, a receiver device may be located in (or adjacent to) the measurement area to capture (e.g., to detect) the modulated signal from the measurement area. The modulated signal may be an audio signal, an RF signal, and/or the like that is modulated to amplify body vibrations of one or more persons located in the measurement area. In this case, a transmitter device may transmit the modulated signal toward the measurement area, and the receiver device may capture (e.g., may detect) the modulated signal that reflects off one or more persons located within the measurement area.

A reflected signal (e.g., a reflection signal) may be isolated from the modulated signal at block 910. For example, in some embodiments, the received modulated signal may be a mixed signal (e.g., mixed with the modulated signal transmitted by one or more transmitter devices and mixed with reflected signals corresponding to the modulated signals reflecting off objects in the measurement area), such that the reflections (e.g., the reflected signals) may be separated from the received mixed signal. A biometric pattern may be extracted (e.g., may be estimated) from the reflected signal at block 910. For example, in some embodiments, the biometric pattern may be calculated from amplitude envelops of inter-wavelet intervals identified from the reflected signal. In other embodiments, the biometric pattern may be extracted from the reflected signals using a suitable filter (e.g., a low-pass filter, a band-pass filter, and/or the like).

In some embodiments, after the biometric pattern is extracted from the reflected signals, the method 900 may end, or may continue with outputting the estimated biometrics information to a user (e.g., via a display device). In some embodiments, as shown in FIG. 9, after the biometric pattern is extracted from the reflected signals, the method 900 may continue to block 920 where the system 100 determines whether the extracted biometric information is abnormal. For example, in some embodiments, the system 100 (e.g., one or more devices of the system 100) may compare the extracted biometric information with historical biometric information of the user to determine whether the extracted biometric information is abnormal at block 920. In this case, if the biometric pattern is normal (e.g., NO at block 920), the system 100 may continue to monitor the biometrics of the user at block 925 using the method 900 and/or the like. On the other hand, if the biometric pattern is abnormal (e.g., YES at block 920), the system 100 may trigger an alert to be transmitted to the user, a medical professional, a first responder, and/or the like to notify of the abnormal biometrics the user detected by the system 100.

While one or more example embodiments of the present disclosure have been described with respect to the transmitting devices of the contactless monitoring system being configured to transmit modulated signals (and/or phase shifted signals) into the environment, the present disclosure is not limited thereto. For example, in some embodiments, not all transmitter devices may be ancillary devices that are configured to be a part of the contactless monitoring system. In this case, these transmitter devices may correspond to existing devices (e.g., smart home appliances) that have no pre-configured setup (e.g., that are not directly controlled by the contactless monitoring system). However, these transmitter devices may transmit various different kinds of source signals (e.g., audio signals, RF signals, and/or the like) into the environment 150 that may be detected (e.g., may be received) by a receiver device or a main monitoring device of the contactless monitoring system to improve accuracy of the contactless monitoring system.

In the drawings, the relative sizes of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” and “including,” “has, ” “have, ” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present disclosure described herein (e.g., the signal modulator 206, the signal separator 216, the biometrics extractor 218, the device mapper 508, the object localizer 510, the object tracker 512, the biometrics estimator 608, the loss calculator 610, the optimizer 612, and/or the like) may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the example embodiments of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Although some example embodiments have been described, those skilled in the art will readily appreciate that various modifications are possible in the example embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific example embodiments disclosed herein, and that various modifications to the disclosed example embodiments, as well as other example embodiments, are intended to be included within the spirit and scope of the present disclosure as defined in the appended claims, and their equivalents.

What is claimed is:

1. A contactless biometrics monitoring system, comprising:
a first device configured to transmit a modulated signal into an environment, the modulated signal being modulated to amplify one or more biometric patterns of a user located within the environment; and
a second device configured to receive a reflection of the modulated signal off the user located within the environment,
wherein the reflection comprises a vibration component, and the vibration component indicates biometric information of the user corresponding to the one or more biometric patterns amplified by the modulated signal.

2. The system of claim 1, wherein the first device is configured to generate the modulated signal by modulating a source audio signal or a source radio frequency (RF) signal according to a frequency range of the one or more biometric patterns.

3. The system of claim 1, wherein the second device is further configured to isolate the reflection from the modulated signal.

4. The system of claim 1, wherein:
one of the first device and the second device is configured as a main device, and the other of the first device and the second device is configured as an ancillary device; and
the main device is configured to dynamically activate the ancillary device into the system according to a location of the user within the environment.

5. The system of claim 4, wherein to dynamically activate the ancillary device into the system, the main device is configured to:
transmit a modulated initialization signal toward a measurement area of the environment;
detect a response transmitted by the ancillary device located within the measurement area of the environment; and
generate a geographic distance map between the main device and the ancillary device that transmits the response.

6. The system of claim 5, wherein the ancillary device is configured to:
detect the initialization signal from the environment;
compare a signal strength of the initialization signal with a threshold strength; and
transmit the response into the environment in response to the signal strength being greater than the threshold strength.

7. The system of claim 5, wherein the main device is further configured to:
calculate a signal variation in the measurement area;
compare the signal variation in the measurement area with that of an adjacent area; and
determine that the measurement area includes a moving object in response to the signal variation in the measurement area being greater than that of the adjacent area.

8. The system of claim 1, further comprising:
a processor; and
memory connected to the processor and storing instructions that, when executed by the processor, cause the processor to:
apply a convolution to the reflection to determine reflected wavelet locations; and
extract the biometric information from the reflected wavelet locations.

9. The system of claim 8, wherein to extract the biometric information from the reflected wavelet locations, the instructions further cause the processor to:
calculate an inter-wavelet interval from the reflected wavelet locations; and
extract the biometric information from the inter-wavelet interval.

10. The system of claim 8, wherein to extract the biometric information from the reflected wavelet locations, the instructions further cause the processor to:
calculate amplitude envelops of the reflected wavelet locations; and
extract the biometric information from the amplitude envelops.

11. The system of claim 8, further comprising:
a biometrics estimation training system communicably connected to the processor; and
a contact device communicably connected to the biometrics estimation training system, and configured to provide biometrics measurements of the user to the biometrics estimation training system,
wherein the biometrics estimation training system is configured to train an optimizer to estimate the biometric information from the reflection by minimizing a loss between the extracted biometric information and the biometrics measurements provided by the contact device.

12. A method for contactless biometrics monitoring, comprising:
transmitting, by a first device, a modulated signal into an environment, the modulated signal being modulated to amplify one or more biometric patterns of a user located within the environment;
receiving, by a second device, the modulated signal reflecting off the user located within the environment; and
isolating, by the second device, a reflection from the modulated signal,
wherein the reflection comprises a vibration component, and the vibration component indicates biometric information of the user corresponding to the one or more biometric patterns amplified by the modulated signal.

13. The method of claim 12, further comprising:
generating, by the first device, the modulated signal by modulating a source audio signal or a source radio frequency (RF) signal according to a frequency range of the one or more biometric patterns.

14. The method of claim 12, wherein one of the first device and the second device is configured as a main device, and the other of the first device and the second device is configured as an ancillary device, and the method further comprises:
dynamically activating, by the main device, the ancillary device according to a location of the user within the environment.

15. The method of claim 14,
wherein to dynamically activate the ancillary device, the method further comprises:
transmitting, by the main device, a modulated initialization signal toward a measurement area of the environment;
detecting, by the main device, a response transmitted by the ancillary device located within the measurement area of the environment; and
generating, by the main device, a geographic distance map between the main device and the ancillary device that transmits the response, and
wherein to transmit the response by the ancillary device, the method further comprises:
detecting, by the ancillary device, the initialization signal from the environment;
comparing, by the ancillary device, a signal strength of the initialization signal with a threshold strength; and
transmitting, by the ancillary device, the response into the environment in response to the signal strength being greater than the threshold strength.

16. The method of claim 14, further comprising:
calculating, by the main device, a signal variation in the measurement area;
comparing, by the main device, the signal variation in the measurement area with that of an adjacent area; and
determining, by the main device, that the measurement area includes a moving object in response to the signal variation in the measurement area being greater than that of the adjacent area.

17. The method of claim 12, further comprising:
applying, by a processor, a convolution to the reflection to determine reflected wavelet locations; and
extracting, by the processor, the biometric information from the reflected wavelet locations.

18. The method of claim 17, wherein to extract the biometric information from the reflected wavelet locations, the method further comprises:
calculating, by the processor, an inter-wavelet interval from the reflected wavelet locations; and
extracting, by the processor, the biometric information from the inter-wavelet interval.

19. The method of claim 17, wherein to extract the biometric information from the reflected wavelet locations, the method further comprises:
calculating, by the processor, amplitude envelops of the reflected wavelet locations; and
extracting, by the processor, the biometric information from the amplitude envelops.

20. The method of claim 17, further comprising:
receiving, by a training system, biometric measurements of the user from a contact device; and
training, by the training system, the processor to estimate the biometric information from the reflection by minimizing a loss between the extracted biometric information and the biometrics measurements provided by the contact device.
